(19) United States
(12) Patent Application Publication
(10) Pub. No.: US 2018/0189805 A1
(43) Pub. Date: Jul. 5, 2018

(54) METHOD AND SYSTEM FOR GENERATING SOCIAL GRAPH INFORMATION

(71) Applicant: BCE INC., Verdun (CA)

(72) Inventors: Nicholas LEBESIS, Milton (CA); Alexander WONG, Markham (CA)

(21) Appl. No.: 15/850,618

(22) Filed: Dec. 21, 2017

Related U.S. Application Data
(60) Provisional application No. 62/440,154, filed on Dec. 29, 2016.

(51) Int. Cl. G06Q 30/02; G06F 17/30; G06Q 50/00

(52) U.S. Cl. CPC G06Q 30/0201; G06F 17/30958; G06Q 50/01; G06Q 30/0269; G06F 17/30867

(57) ABSTRACT

Methods and systems for using mobile data to generate social graph information are disclosed. Using the social graph information for targeted advertising is further disclosed herein. Mobile data from a telecommunications network is received at one or more network servers and processed to generate node and edge information in a social graph. The mobile data may be used to infer relationships and develop a social graph profile for a node. The social graph profile can be used to implement targeted advertising. Data from the mobile network may also be merged with connected object data or data provided by Internet of Things (IoT) devices, allowing for the creation of social graphs according to interactions between users of devices as well as interactions with IoT devices. Targeting advertisements to nodes that have been within a definable proximity to connected products in the real world is also disclosed.

### RELATED APPLICATIONS

The current application claims priority to U.S. Provisional Patent Application 62/440,154 Filed Dec. 29, 2016, the entire contents of which are incorporated herein by reference.

### TECHNICAL FIELD

The present disclosure relates to generating and using social graph information.

### BACKGROUND

Industries and organizations seek to better collect, understand, and act on customer data. Online networks such as social networks (e.g. Facebook, Twitter, etc.) have been successful in joining large datasets in order to form complex social graphs, allowing them to compete with companies such as Google in the multi-billion dollar advertising industry. Telecommunication companies also compete for advertising revenue, traditionally selling advertisers space across their web, applications, radio, out-of-home, print, and/or TV properties. This type of advertising is wide-net antiquated targeting, which is generally less effective than behaviour-based targeting programs being offered by technology innovators such as those mentioned above.

Behaviour-based targeting allows advertisers to accurately target customers based on numerous data points relating to consumer interests and behaviours. However, telecommunications companies do not have traditional social network data, as would exist with Facebook, for example, making it difficult for traditional telecommunications companies to develop social graphs that could be used for behaviour-based targeting.

Accordingly, systems and methods that allow for social graphs to be generated using mobile data remains highly desirable.

### BRIEF DESCRIPTION OF THE DRAWINGS

Further features and advantages of the present disclosure will become apparent from the following detailed description, taken in combination with the appended drawings, in which:

FIG. 1 depicts a system for receiving network data and generating social graph information;

FIG. 2 depicts a method executed by a server for generating social graph information;

FIG. 3A shows a conceptual diagram of a database for storing nodes and edges;

FIG. 3B shows a schematic diagram of a simplified social graph;

FIG. 4 shows a conceptual diagram of a profiling database;

FIG. 5 depicts a system for performing targeted advertising over a mobility network;

FIG. 6 depicts a method executed by a server for performing targeted advertising over a mobility network;

FIG. 7 depicts a communication flow diagram for generating social graph information and using it to perform targeted advertising;

FIG. 8 depicts an example of targeted advertising to a social group;

FIG. 9 depicts an example of targeted advertising to a social group using Internet of Things devices;

FIG. 10 depicts an example of targeted advertising based on proximity determination; and

FIG. 11 depicts a communication flow diagram for targeted advertising based on proximity determination.

It will be noted that throughout the appended drawings, like features are identified by like reference numerals.

### DETAILED DESCRIPTION

In accordance with the present disclosure there is provided a method of generating social graph information, comprising: receiving mobile data from a device corresponding to a first node within a set of a plurality of nodes; generating an edge between the first node and a second node within the set of the plurality of nodes based on the mobile data received, the edge representing how the first node and the second node are connected; inferring a relationship between the first node and the second node based on the edge; generating a social graph profile for at least one of the first node and the second node based on the inferred relationship; and storing the social graph profile in a profiling database.

In a further embodiment of the method, the relationship is inferred based on the edge and one or more existing edges generated from previously received mobile data.

In a further embodiment of the method, the relationship is inferred by applying one or more relationship threshold parameters to the edge and the one or more existing edges.

In a further embodiment of the method, the edge is any one or more of: a call between the first and second nodes, a text message between the first and second nodes, and location proximity of the first and second nodes.

In a further embodiment of the method, the social graph profile further comprises customer relationship management information.

In a further embodiment of the method, the mobile data comprises any one or more of text messages, phone calls, e-mails, browsing activity, and location information.

In a further embodiment, the method further comprises: receiving an advertising request from an advertising server, the advertising request include target profile parameters; determining one or more target nodes by querying the profiling database for one or more nodes that match the target profile parameters; retrieving a social graph profile associated with each of the one or more target nodes; and transmitting the social graph profile to the advertising server.

In a further embodiment of the method, the one or more target nodes have subscribed to a targeted advertising program.

In a further embodiment of the method, the first node is determined to be a targeted node based on the first node's relationship with the second node.

In accordance with a further embodiment of the present disclosure, there is provided a system for generating social graph information, comprising: a network server operably coupled with a mobile network; and a memory operably coupled with the network server, the memory containing instructions which when executed by the network server configure the network server to: receive mobile data from a device corresponding to a first node within a set of a plurality of nodes; generate an edge between the first node and a second node within the set of the plurality of nodes based on the mobile data received, the edge representing how the first node and the second node are connected; infer a relationship between the first node and the second node based on the edge; generate a social graph profile for at least one of the first node and the second node based on the inferred relationship; and store the social graph profile in a profiling database.

In a further embodiment of the system, the relationship is inferred based on the edge and one or more existing edges generated from previously received mobile data.

In a further embodiment of the system, the relationship is inferred by applying one or more relationship threshold parameters to the edge and the one or more existing edges.

In a further embodiment of the system, the edge is any one or more of: a call between the first and second nodes, a text message between the first and second nodes, and location proximity of the first and second nodes.

In a further embodiment of the system, the social graph profile further comprises customer relationship management information.

In a further embodiment of the system, the mobile data comprises any one or more of text messages, phone calls, e-mails, browsing activity, or location.

In a further embodiment of the system, the memory contains further instructions which when executed by the network server configure the network server to: receive an advertising request from an advertising server, the advertising request include target profile parameters; determine one or more target nodes by querying the profiling database for one or more nodes that match the target profile parameters; retrieve a social graph profile associated with each of the one or more target nodes; and transmit the social graph profile to the advertising server.

In a further embodiment of the system, the one or more target nodes have subscribed to a targeted advertising program.

In a further embodiment of the system, the first node is determined to be a targeted node based on the first node's relationship with the second node.

Methods and systems for using mobile data to generate social graph information are disclosed. Using the social graph information for targeted advertising is further disclosed herein. Mobile data from a telecommunications network is received at one or more network servers and processed to generate node and edge information of a social graph. The mobile data may comprise a telecommunication company's network data such as phone calls, text messages, e-mails, browsing data, location information, etc. The mobile data may be used to infer relationships that can lead to a better understanding of mobile network customers and their connections, and allow for social graph profiles of nodes to be developed. The social graph profiles can be used to implement targeted advertising to users of devices on the mobile network. Data from the mobile network may also be merged with connected object data or data provided by Internet of Things (IoT) devices, allowing for the creation of social graphs according to interactions between users of devices as well as interactions with IoT devices. This combination of user and IoT interaction data allows targeting advertisements to audiences who have been within a definable proximity to connected products in the real world.

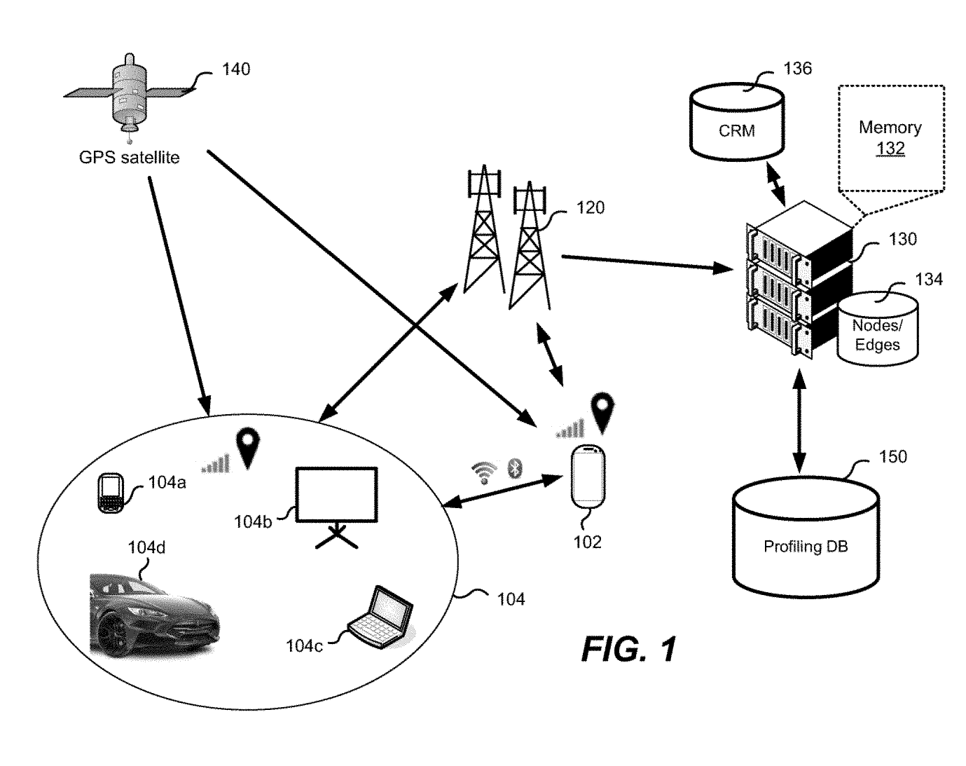

Embodiments are described below, by way of example only, with reference to FIGS. 1-11.

FIG. 1 depicts a system for receiving network data and generating social graph information. The system shown allows for a network provider to generate social graphs of users and devices as they interact over the network. Device 102 (depicted as a mobile phone for the sake of example, but should be understood as not being limited to such) is connected to a mobile network provided by a service provider. The device 102 may communicate with other devices capable of being connected to a network, and the devices with this functionality are herein referred to as connected devices 104. The connected devices 104 may include devices such as other mobile devices and/or any device that is part of the growing number of Internet of Things (IoT). Connected devices 104 may be another mobile device 104a, a smart TV 104b, a laptop 104c, a ‘smart car’ 104d (i.e. a car equipped with communication equipment), etc. These connected devices may similarly be connected to a mobility network. In addition to their network connection capabilities, the device 102 and connected devices 104 may also have location services/capabilities. The device 102 and the connected devices 104 may comprise a GPS receiver, allowing for their location to be determined.

Communication between device 102 and the connected devices 104 may be over a mobile network, with the information being transferred via cellular towers 120. For example, this communication may include text messages, phone calls, e-mails, etc., but is not limited to such. Mobile data pertaining to the interaction between devices, such as call detail records, location of the devices, etc., may be provided to one or more network servers 130 operably coupled to the cellular towers 120 and the mobility network.

The connected devices 104 do not necessarily need to be connected to the mobile network for the communicated information to be received at the one or more network servers 130. For example, the connected devices 104 may be connected to a different mobile network than the mobile network provided by cellular towers 120. However, communication between device 102, which is connected to the mobile network provided by cellular towers 120, and the connected devices 104 would still traverse the mobile network provided by cellular towers 120, and therefore the mobile data between the devices on different networks may still be provided to the one or more network servers 130. Communication may also occur between the device 102 and the connected devices 104 locally, for example through Wi-Fi or Bluetooth. With the device 102 connected to the mobility network, the information from the local communication with connected devices 104 may still be provided through the cellular towers 120 and sent to the one or more network servers 130. In essence, any information that crosses the mobile network may be captured and sent to the one or more network servers 130. Location information of the device 102 and connected devices 104 may also be determined, for example from signals received by a GPS satellite 140. The device 102 and connected devices 104 may also provide this location information to the one or more network servers 130.

The data associated with the device 102 and one or more of the connected devices 104 may be received by the one or more network servers 130. The received data may be collectively referred to as mobile data. The mobile data may comprise data such as phone calls, text messages, browsing data, location information, etc. For example, the mobile data may comprise a call detail record. If two devices communicate via a phone call, the details of the call including the respective phone numbers, call time, duration, etc., may be received. If two devices communicate over short message system (e.g. text messaging), the details of the text including the respective phone numbers, text time, etc., may be received. The details of browsing data, such as length of time on the Internet, websites visited, data used, downloads, etc., may be received. The location information may include data such as location co-ordinates, time arrived at different locations, duration spent at different locations, etc. Mobile data such as phone calls and text messages may be received from devices that are associated with any mobile network service provider. All mobile data may be received from devices that are primarily connected to the mobile network provided by the cellular towers 120, whereas only mobile data that crosses the mobile network provided by the cellular towers 120 may be received for devices that are not primarily connected to that mobile network. Mobile data such as browsing data and location information may only be received from devices that are connected to the mobile network provided by the cellular towers 120.

As will be appreciated by a person skilled in the art, the various types of mobile data may be received at different servers and subsequently provided to the one or more network servers 130 for determining the social graph information. The system shown in FIG. 1 is simplified for the purposes of clarity and may omit elements of the system. As will be further appreciated by a person skilled in the art, the above-described types of mobile data are exemplary in nature, and other types of mobile data, as well as other data contained within the mobile data, may be received.

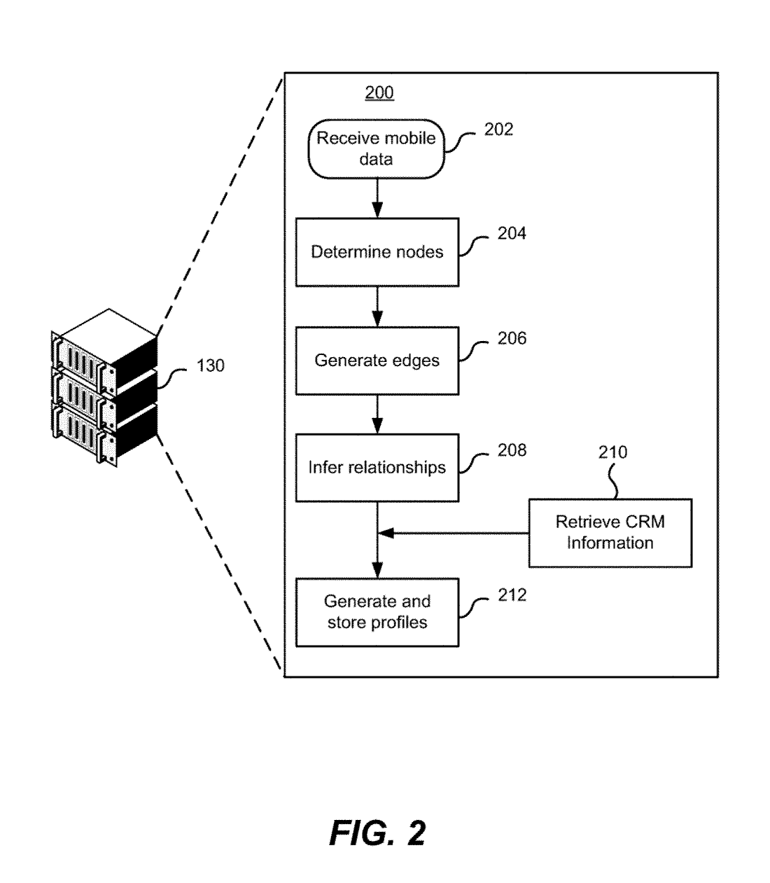

As further described herein with reference to FIG. 2, the one or more network servers 130 can use the mobile data to generate social graph information. Operably coupled with the one or more network servers 130 may be a memory 132 that stores computer-executable instructions. When the computer-executable instructions are executed by a processor of the one or more network servers 130, the network servers 130 may be configured to generate the social graph information.

Also coupled with the one or more network servers 130 may be a nodes and edges database 134 for storing intermediary social graph information as it is determined. A customer relationship management (CRM) database 136 may also be operably coupled with the one or more network servers 130. The CRM database 136 may store information associated with customers of the mobile network. The CRM database 136 may be populated with data received by the customer when joining the mobile network, for example. The CRM database may further indicate whether a mobile customer has subscribed to targeted advertising, as will be further described herein. Using the received mobile data, as well as possibly using CRM information from the CRM database 136, the nodes and edges information may be determined and stored in the nodes and edges database 134. Further, based on the nodes and edges information, social graph profiles for the mobile customers corresponding to respective nodes may be generated by the one or more network servers 130 and stored, for example in a profiling database 150, for future use and updating as will also be described further herein.

FIG. 2 depicts a method executed by a server for generating social graph information. The method may be stored in memory as computer-executable instructions and be executed by a processor of the one or more network servers 130. As will be further described herein, a social graph provides a map of relationships that may be used to understand how information is connected and tied across the mobile network. The method 200 comprises receiving the mobile data at the one or more network servers 130 (202). As described with reference to FIG. 1, such network data may comprise text messages or phone calls sent between devices over the mobile network, Internet browsing activity, IoT device information, physical location of devices, etc., to name a few non-limiting examples.

Nodes can be determined from the network data (204). The nodes may represent actors such as subscribers, users, individuals, etc., and the objects being observed. For example, people or users of devices may be represented as primary nodes, and connected objects may be represented as a complimentary secondary layer of node information (secondary′ because the main advertising focus ultimately relates back to individuals). The network data received may be from a mobile device corresponding to a first node associated with a mobile user within a set of mobile users connected to the network. The network data received may comprise such data as the sender, receiver, header information, etc. The sender and receiver may be identified by a MAC address or other identifier, including for example an IP address. This information may be used to determine/identify nodes from the mobile data. A type of the node(s) may also be identified, for example whether it is a user's mobile phone, smart TV, etc. Identifying the type of node may be based on the network data received. For example, the received network data may include one or more identifiers useful in identifying the device type the data was provided by. The node information may be stored in an intermediary database or storage, such as the node and edge information database 134.

Edges between the nodes are generated (206), which represent how the nodes are connected. The edges provide relationship context between the nodes, and may be established by interpreting data points received from the network data as well as other data sources. For example, an edge may be representative of a phone call or text message between nodes, or a location proximity of two nodes. Edges may be bi-directional, that is, an edge linking a first node to a second node may also link the second node to the first node. Edge patterns related to time and day, frequency, and volume may influence the degree in which a relationship is inferred. The computer-executable instructions may provide a model that is flexible in distributing weights across the social graph to infer the edges. For example, a phone call may be given more weight than a text message. Furthermore, the model may be updated, and retrained, at a specified rate. The edge information may be stored in an intermediary database or storage, such as the node and edge information database 134.

The edge information may be used to infer relationships (208) between the nodes with which the edge connects. The one or more network servers 130 may be configured by the execution of the computer-executable instructions to determine relationships based on relationship threshold parameters stored in the memory 132. For example, if a first node has texted a second node one time, their relationship may not be considered a friendship. However, if the first node has texted the second node more than ten times in a week, they may be inferred as friends. In this case, each text is an edge between the nodes, and the relationship is whether or not they are friends. Accordingly, the one or more network servers 130 may use existing social graph information stored in the nodes and edges database 134 to arrive at this inference of a relationship between nodes. Other types of relationships that may be inferred could be father, son, acquaintance, colleague, etc., to name a few non-limiting examples. Such relationships may be useful for targeted advertising, as will be further described herein.

Distinct social graph relationships may be determined through analyzing and modelling of the received mobility data along with previously stored node and edge information. The determination of the social graph relationships may be accomplished using neural network/support vector machine (SVM) modelling techniques. Examples of the relationships that may be discovered include, but are not limited to, homophily (which is the degree in which similar nodes befriend each other), propinquity (which is the tendency for actors to have more ties with those who are geographically close), social network potential (which is the size of one's social network, and speaks to their influencing power), and transitivity (which is the tendency for an individual's friends to also be friends, thus forming a closure and a social network clique). For example, information associated with two nodes stored in the profiling database 150 may reveal that one node belongs to a user that is a 25 year old male, one node belongs to a user that is a 25 year old female, the two nodes are located in close proximity on weekends, and that the frequency of calling and texting in the evenings is high. The one or more network servers 130 may categorize these nodes as being in a relationship, which may then be used for targeted advertising as will be described further herein.

The inferred relationships may be used to generate or update social graph profiles for each node, which may be stored for example in a profiling database 150 (212). The one or more network servers 130 may also retrieve information from CRM database 136 and input this into the profiling database 150 (210). For example, certain characteristics of the users of devices can be retrieved from the CRM database 136. These may have been established when a user purchased the device, and/or upon opting-in for the targeted advertising. Similarly, an advertising identifier may be retrieved from the CRM database 136, indicating that the user of the relevant device has opted-in/subscribed to the targeted advertising service.

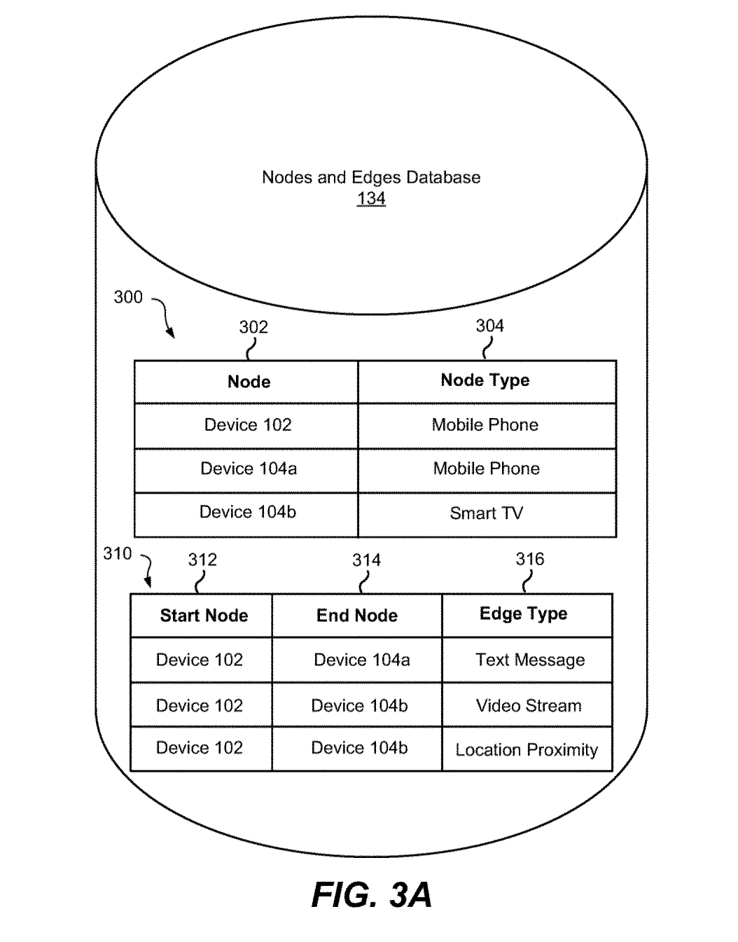

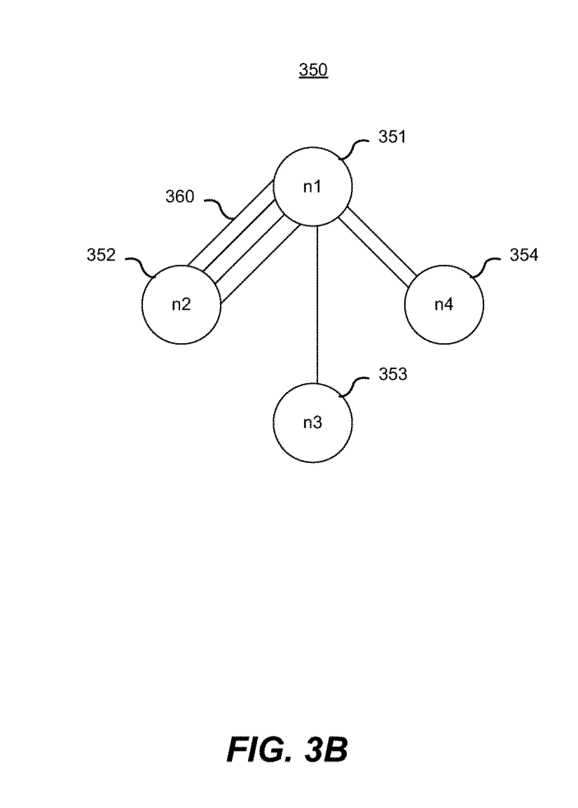

FIG. 3A shows a conceptual diagram of a database for storing nodes and edges. Column 302 in the upper table 300 within the nodes and edges database 134 denotes a node that has been identified within mobile data received at the one or more network servers 130. The node may have been identified by an identifier of the device to which the node corresponds in the network data (for example a MAC address for the node). The node type may also be identified as shown listed in column 304. The node type may be determined from the network data as well, and/or by accessing the CRM database 136 coupled with the one or more network servers 130. For example, the CRM database may include a correspondence between information in the network data such as an IP address or MAC address of the node and a device type such as a type of television receiver, mobile device, etc.

As previously described, a node may correspond to a device connected to the mobility network (e.g. Device 102), or more particularly a user of the device, but nodes can still be determined for users of devices connected to other networks. Consider an example where device 102 calls device 104a. If mobile device 102 is connected to the network, this mobile data is sent to the one or more network servers 130. The sender and receiver information contained in the network data could allow for the nodes to be identified and their device types determined. If device 104a is using the same mobility network, the network data from that device would also be sent to the one or more servers 130. However, even if device 104a is using a different mobility network, node information can be determined from the network data sent from device 102. A similar example for communication between device 102 and smart TV 104b, perhaps streaming of a video from device 102 on the smart TV 104b, could result in determining additional and/or new node information.

As described with reference to FIG. 2, edge information is used to ‘link’ nodes together and represents how two nodes are connected. Column 312 in the lower table 310 within the nodes and edges database 134 denotes the first node, for example the sender, of the communication contained in the mobile data. Likewise, column 314 denotes the second node, for example the receiver, of the communication contained in the mobile data. The edge type that has been generated by the one or more network servers 130 is shown listed in column 316 within the edge information database 134b. The edge type may be determined based on the received mobile data.

For example, an edge that connects the nodes corresponding to device 102 and device 104a may be a text message. An edge that connects the nodes corresponding to device 102 and device 104b may be a video stream. Device 102 and device 104b may also be linked by location proximity. In determining the location proximity, the one or more network servers 130 may use location data received to determine that the mobile device 102 is near smart TV 104b every week day for one hour at 8 pm. Thus the edge linking these two nodes is their location. Again, the smart TV 104b does not need to be connected to the mobility network. It may be known that the smart TV 104b is in close proximity to the mobile device 102 because the device 102 connects to wirelessly to stream videos and this network data from the device 102 is sent to the one or more network servers 130. Additionally or alternatively, the smart TV 104b may have location capabilities such that its location can be determined and sent to the one or more network servers 130. Running a comparison of the device 102 location with the smart TVs 104b location may result in finding the above-mentioned frequency in location proximity, allowing for this edge to be constructed.

The nodes and edges database 134 may be dynamic and continuously updated as network data is received and processed by the one or more network servers 130.

FIG. 3B shows a schematic diagram of a simplified social graph. The social graph 350 comprises several nodes 351, 352, 353, and 354, as well as edges between the nodes, where each edge is depicted as a line connecting two nodes, such as edge 360. The social graph 350 represents another possibility of how data in the nodes and edges database 134 may be presented.

The nodes 351, 352, 353, and 354 may represent users of devices. Each edge 360 may represent a connection between two nodes. Each edge may represent a different type of connection such as a phone call, text message, location proximity, etc. As previously described, the edges 360 between nodes may be used to infer relationships between nodes. Thus, more edges between two nodes may be indicative of a stronger relationship. For example, the first node 351 may have a stronger relationship with the second node 352 than it does with the third node 353 or fourth node 354.

More edges between two nodes may also help to improve the accuracy of an inferred relationship between nodes. As previously described, a relationship may only be inferred after a relationship threshold parameter has been satisfied. For example, if a node has called a pizza restaurant one time, this may not be considered a relationship. However, if the node calls the same pizza restaurant every Saturday night, then a relationship between the user of the node and the pizza restaurant may be inferred. Other types of criteria/weights/thresholds may be applied to the received mobile data, as would be appreciated by a person skilled in the art.

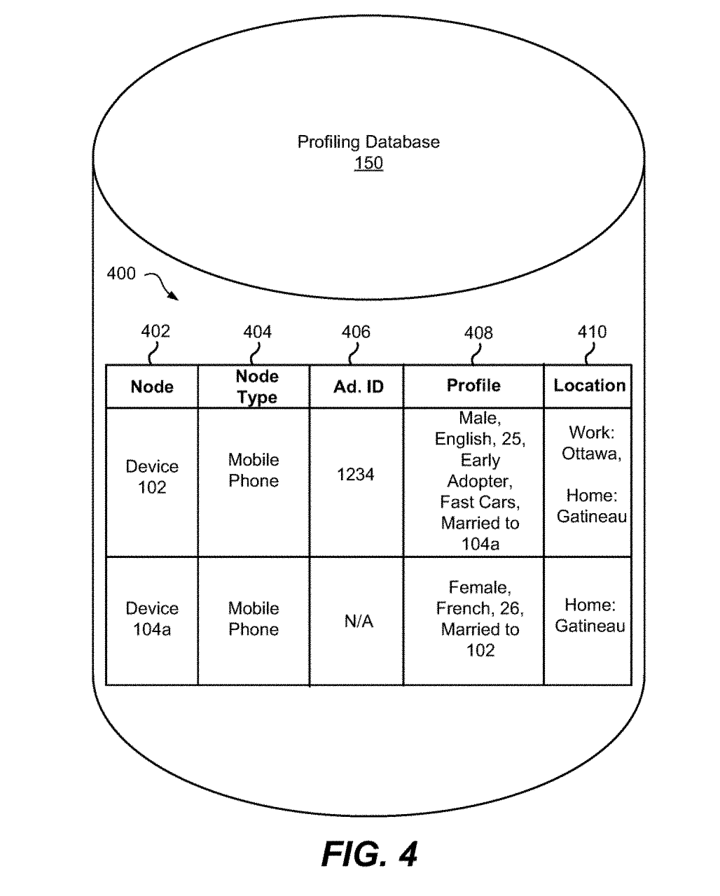

As will be further described with reference to FIG. 4, the social graph information and relationships inferred therefrom may be used to determine a social graph profile for respective nodes. In the above example, the relationship between the node and the pizza restaurant may be used to identify that the user of the node really likes to eat pizza. The social graph information may also be useful in identifying the previously described types of relationships such as homophily, propinquity, social network potential, and transitivity. This more specific relationship information may also be useful in generating social graph profiles. In the simplified social graph 350 depicted in FIG. 3B, it may be determined that the four nodes 351, 352, 353, and 354 do not display transitivity because the friends of the first node 351 (e.g., nodes 352, 353, and 354) are not friends with each other. It may be further determined that the first node 351 is therefore a social network influencer, having more friends, relationships, or stronger connections than most of the other nodes.

The above-described example of a social graph with reference to FIG. 3B is simplified for the purpose of explanation, and it would be readily apparent to a person skilled in the art that social graphs may be much more complex, and consequently can glean further insights from the inferred relationships.

FIG. 4 shows a conceptual diagram of a profiling database. This may be used to store social graph profiles that have been generated for each node using inferred relationships between nodes of the social graph as well as CRM data. The social graph database 150 in FIG. 4 conceptually shows what information processed from the network data may be stored in the social graph profiles, which in turn may be used for targeting advertisements. Information that may be captured over the mobility network or other sources and that may be used to determine the node profiles includes, but is not limited to: demographics (gender, age, language, etc.), behavioural (web traffic, interest categories, TV programs, etc.), location (home, work, etc.), device (device type, device model, device operating system, IoT devices), etc. Such profiling datasets may be beneficial to development of the social graph profiles associated with each node.

Column 402 in the table 400 within profiling database 150 denotes the node with which the social graph profile is associated with. Column 404 denotes the node type, which may for example be the type of device associated with the node. This information may have been retrieved from the nodes and edges database 134. The advertising ID may be listed as shown in column 406, which may be retrieved from the CRM database 136, and represents whether or not the user of a device has opted-in for receiving targeted advertisements. Note that if there is no advertising ID for a node, which means that the node has not subscribed to the targeted advertising program, a social graph profile for the node may still be generated. This may be useful for targeted advertising of nodes that have subscribed to targeted advertising and are connected with the unsubscribed node, as well as in a scenario where the unsubscribed node may subscribe to targeted advertising at a future date. Column 408 denotes a social graph profile for the node, which may have been derived from inferred relationships using edges generated and using CRM data, as previously discussed. Location information may also be recorded as shown in column 410.

Exemplary information is provided in profiling database 150. The information depicted is simplified for the sake of explanation. In the example shown, a node corresponds to a user of device 102, which is a mobile phone that has subscribed to the targeted advertising (indicated by its advertising ID). The user associated with the primary node is an English male that is twenty-five years old. Behaviour data derived from the social graph characteristics and other data sources has inferred that he is an early adopter of new technologies, likes fast cars, and is married to the user of device 104a. Further, location data has revealed that the user of device 102 works in Ottawa and lives in Gatineau. Another node corresponds to a user of device 104a, which is also a mobile phone, but the user of device 104a has not subscribed to the targeted advertising program. The profile for the user of device 104a is sparser compared with that of the user of device 102. This may be the result of the user of device 104 being less active on their device. In another case, the device 104a may be connected to a different mobile network than the mobile network that sends mobile data to the one or more network servers 130, so mobile data from device 104a is only received when the device 104a is in contact with devices connected to the mobility network provided by the cellular towers 120. Nonetheless, social graph information that has been collected for the user of device 104a is that they are a primarily French-speaking female that is twenty-six years old, and is married to the user of device 102. Location information has revealed that her home is in Gatineau.

The profiling database 150 may be dynamic and continuously updated as mobile data is received and processed by the one or more network servers 130. As previously described, relationships may be inferred by looking at edges and other social graph information stored in the nodes and edges database 134. Relationships and social graph profiles may only be best guesses, and the process in inferring relationships may be iterative. Accordingly, social graph profiles may change and evolve over time.

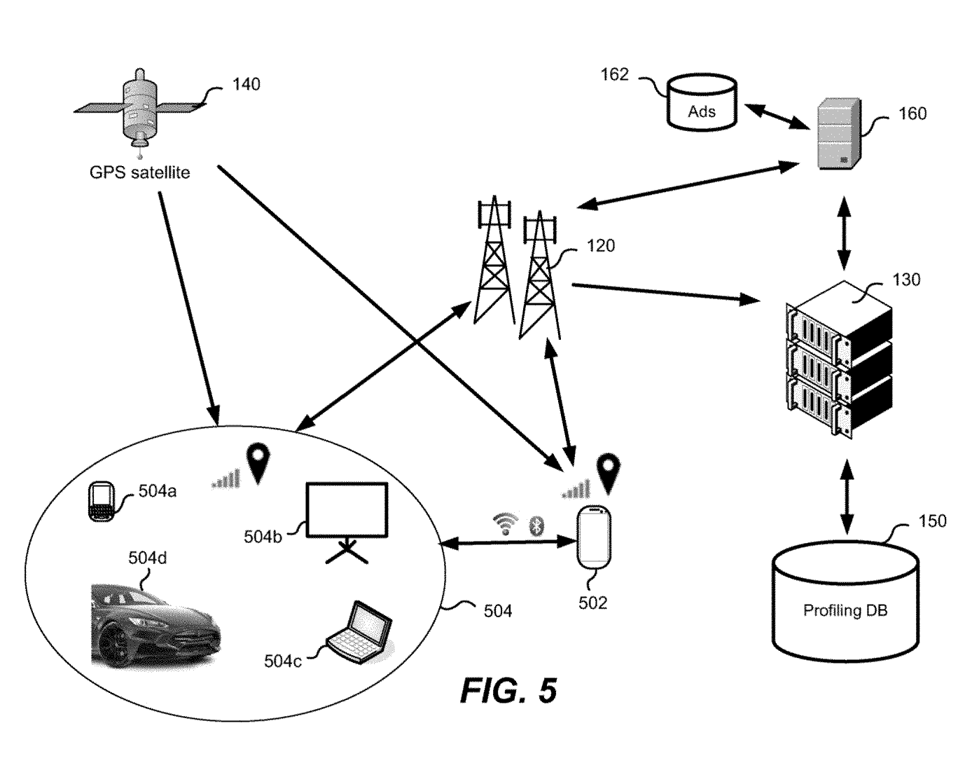

FIG. 5 depicts a system for performing targeted advertising over a mobility network. Social graph profiles may be particularly advantageous for advertising to users of devices on a mobile network, and telecommunications providers may sell or provide social graph profiles so that advertisers can apply behaviour based advertising. Upon establishing a social graph leveraging inferential statistics within a mobile network environment, advertisers will be able to tailor a similar message to targeted social groups. Advertisers can leverage one or multiple of these distinct relationships to focus their advertising. For example, with homophily an advertiser may target social groups who are more likely to propagate their messaging. A viral advertiser could see the diffusion of a message or product, and in turn, optimize their targeting strategies. Using propinquity, advertisers can target messages to cliques for geographical specific campaigns. With social network potential, by finding an influencer among assertive groups a marketer can target these influencers and analyze how a product or message spreads across a clique or broad network. Using transitivity, an advertiser may enter into the mindshare of a closed clique.

The system shown in FIG. 5 may allow for the influencing of a purchasing decision on a mass scale through digital activities, and for re-targeting customers with products they've seen in the real world. The system shown in FIG. 5 is similar to the system shown in FIG. 1, and only the differences will be discussed. The devices have been renumbered to device 502 and connected devices such as mobile device 504a, smart TV 504b, laptop 504c, and smart car 504d (referred to collectively as connected devices 504). This highlights that advertisements do not necessarily have to be sent to the same devices that certain mobile data was received from. The memory 132, node and edge database 134, as well as CRM database 136, have been omitted from FIG. 5 for simplicity. An advertisement server 160 is shown operably coupled to the one or more network servers 130, and coupled with the advertisement server 160 is an advertisement database 162.

The advertisement database 162 may comprise various advertisements that may be displayed to users of the mobility network. The advertisements stored in the advertisement database 162 may be added, modified, deleted, etc. When the advertisement server 160 receives an advertising call from a device it may send an advertisement request to the one or more network servers 130. The advertisement server 160 may also provide target profile parameters to the one or more network servers 130. These target profile parameters may comprise threshold values or other characteristics indicating the characteristics the ad should be targeted to. The one or more network servers 130 can query the profiling database 150 to determine one or more nodes associated with social graph profiles matching the target profile parameters and retrieve these profiles accordingly. The social graph profile information may be provided to the advertisement server 160. The advertisement server 160 may retrieve the advertising content from the advertisement database 162 and display them to users of devices corresponding to targeted nodes. While the advertisement server 160 and the one or more network servers 130 are depicted as being separate for the sake of explanation, it is noted that these may be the same server configured to perform the functionality described.

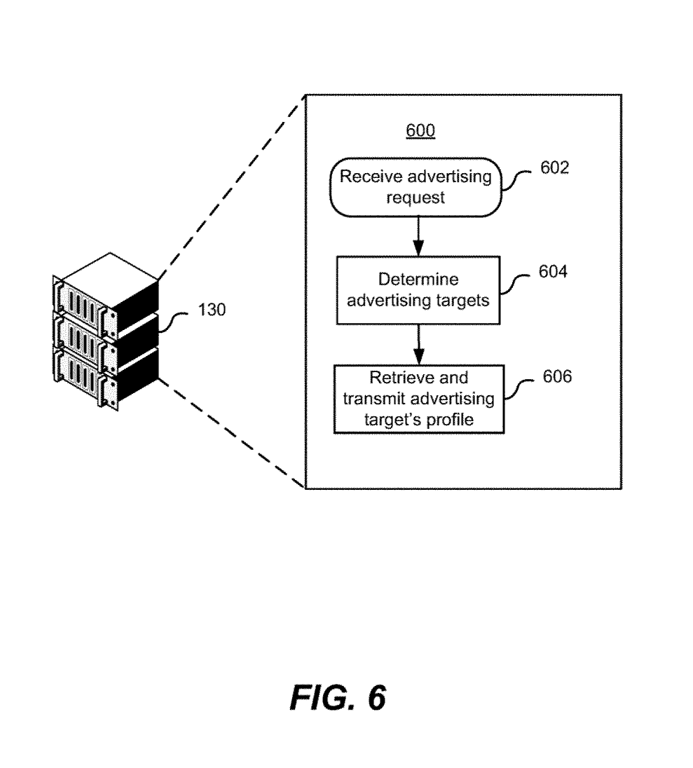

FIG. 6 depicts a method executed by a server for performing targeted advertising over a mobility network. The method may be stored in memory as computer-executable instructions and be executed by a processor of the one or more network servers 130. Method 600 comprises receiving an advertising request (602) at the one or more network servers 130. This may include a request to display a specific advertisement to users with a target profile. The advertiser may provide target profile parameters that the advertising target should have. Alternatively, the advertising request may not indicate desired characteristics of an advertising target, but the one or more network servers 130 may determine advertising targets based on advertising rules, thresholds, etc. stored in its memory 132. The one or more network servers 130 determines advertising targets (604) as target nodes by querying the profiling database 150 for social graph profiles that are relevant to the advertisement and that match the target profile parameters. Consider an example where a boyfriend and girlfriend relationship has been identified. These nodes may be targets for products/services geared toward this relationship, such as restaurants, movies, Tiffany's items, vacations, etc. In another example, nodes can be informed about interests of other nodes in their social network. If a father likes soccer, nodes that have inferred relationships such as his wife and kids may be targeted with soccer gift ideas for birthdays, holidays, etc. The social graph profiles for target nodes that have been determined, or parts of the profile, are retrieved from the profiling database 150 and transmitted to the advertisement server 160 (606), allowing for the advertisement server 160 to send content from the advertisement database 162 to the targeted nodes.

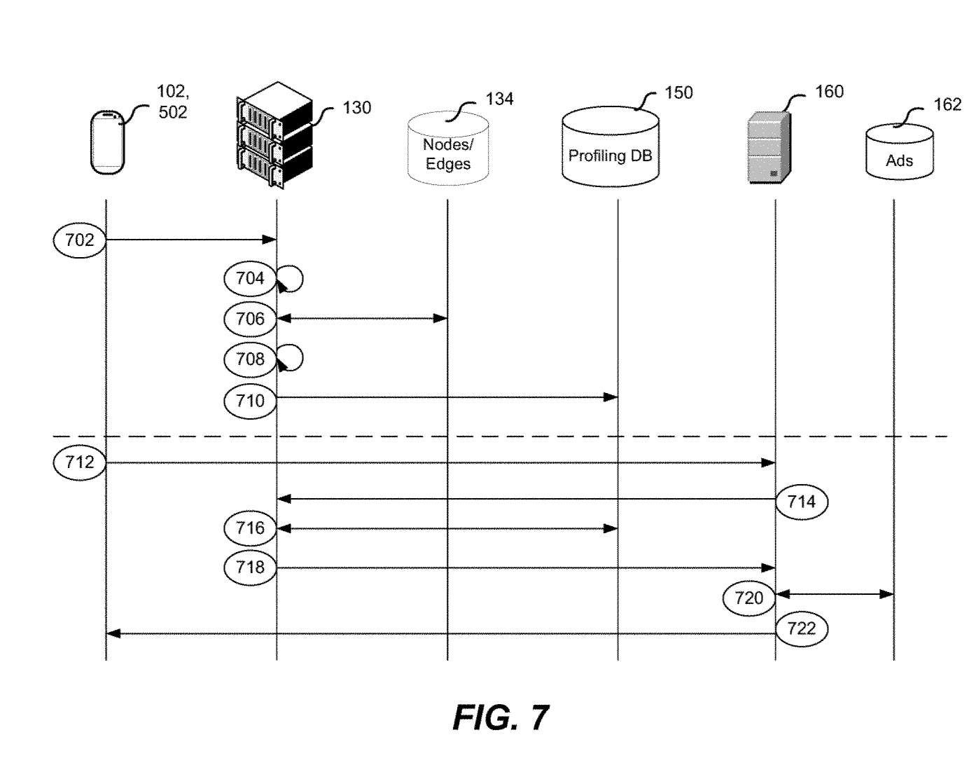

FIG. 7 depicts a communication flow diagram for generating social graph information and using it to perform targeted advertising.

Mobile data is received at the one or more network servers 130 from a node, such as device 102 or 502 (702). The mobile data may comprise phone calls, text messages, e-mails, browsing data, location, etc. The one or more network servers 130 may determine node and edge information based on the received mobile data (704). The node and edge information may be stored in the nodes/edges database 134, and the one or more network servers 130 may also retrieve/access data from the nodes/edges database 134 to be used for inferring relationships (706). The one or more network servers 130 may infer relationships from the social graph information contained in the nodes and edges database 134, and generate a social graph profile for one or more of the nodes (708). The one or more network servers 130 may apply relationship threshold parameters to the edges in the nodes and edges database 134 to infer the relationships. Further, as previously described, the model contained within instructions executed by the one or more network servers 130 for inferring the relationships may be flexible and updatable. The social graph profile may be stored in the profiling database 150 (710). In this example, a social graph profile for the user of device 102 or 502 is stored in the profiling database 150.

The device 102 or 502 may subsequently make an advertisement request from advertisement server 160 (712). This may occur, for example, when the user of the device 102 or 502 visits a webpage with an advertisement located therein. The advertisement server 160 may query the one or more network servers 130 to retrieve a social graph profile, or a part thereof, for the user of device 102 or 502 (714). The one or more network servers 130 may access the profiling database 150 to retrieve the social graph profile for the user of device 102 or 502 (716), and send the social graph profile to the advertisement server 160 (718). The advertisement server 160 may access the advertisement database 162 to retrieve an appropriate/targeted advertisement specific to the user of the device 102 or 502 based on the received social graph profile (720). The advertisement server 160 may send the targeted advertisement to the device 102 or 502 (722).

It is important to note that the steps in the communication flow diagram depicted in FIG. 7 do not necessarily have to be performed in that order. For example, as has been previously described the advertisement server 150 may make requests to the one or more network servers 130 in advance of receiving a request from a device. The request may comprise target profile parameters, thereby allowing the advertisement server 160 to identify target nodes to which it wishes to target with advertisements. The target profile parameters may also represent the relationship threshold parameters for determining relationships between nodes.

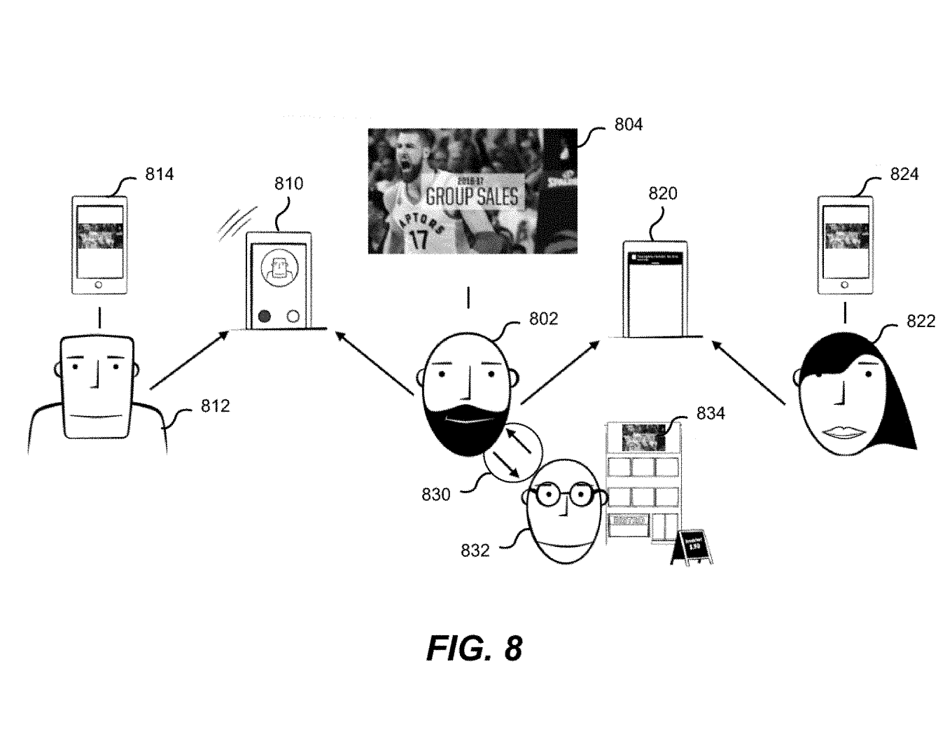

FIGS. 8 thru 11 describe various implementations for using the social graph profiles to advertise based on user behaviours.

FIG. 8 depicts an example of targeted advertising to a social group. FIG. 8 provides an example of targeted advertising to a social group. A user 802 of one or more devices on the mobile network may have been identified as liking sports, and in particular, basketball. This may have been determined for example based on behaviour of watching basketball on TV, visiting ticket websites looking for Toronto Raptors' tickets, etc., and this behaviour may have been stored in the profiling database 150. A request to display advertisement 804 for group tickets to Toronto Raptors game has been received by the one or more network servers 130.

Querying the profiling database 150, the one or more network servers 130 may determine that user 802 makes phone calls 810 to another user 812. Their relationship may be determined as a friendship, based on the number of phone calls, respective ages of the users, etc. User 812 may then be an advertising target for the advertisement 804, and it is displayed on user's phone 814 the next time they open their Internet browser for example. Similarly, it may be determined that user 802 texts 820 with another user 822 frequently. Based on the profile of user 822 stored in the profiling database 150, it may be determined that they are also an advertising target and advertisement 804 is displayed on their device 824. Perhaps user 802 is also connected to user 832 by way of a location proximity 830. For example, it may be determined that they are always in the same location, Monday to Friday, 1 pm-9 pm. It may be determined from their profiles that they both work at a gym for example, implying that user 832 may also be a good advertising target for basketball-related advertisements. The user 832 may be targeted with an out of home digital advertisement 834 is displayed when user 832 is at a coffee shop. The location of user 832 may be tracked by the mobility network (for example through their mobile device), so that the display of digital advertisement 834 could coincide with when user 832 approaches.

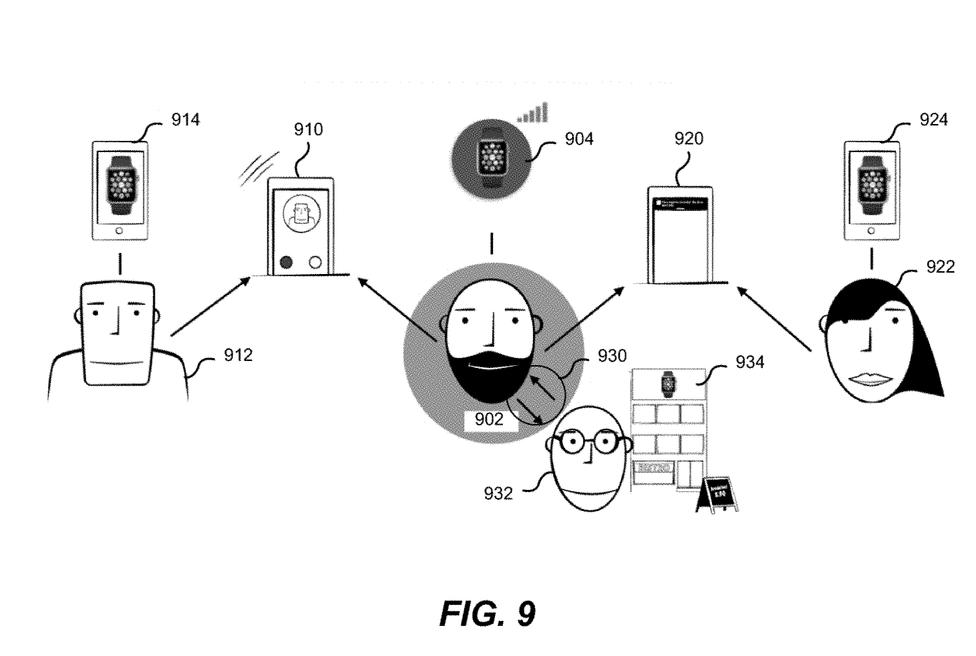

FIG. 9 depicts an example of targeted advertising to a social group with IoT devices. This is another implementation of the targeted advertising described in FIG. 8, allowing advertisers to act on IoT data within their campaigns. In this example, it is determined that user 902 wears a smart watch 904, e.g. an Apple Watch. This may have been determined because the smart watch 904 is also connected to the mobility network. Perhaps user 902 is an early adopter, and the advertiser wants to target social graph nodes who own iPhones, don't own the Apple Watch, but who are connected to someone who does. The advertiser may send a request to the one or more network servers 130, along with the requirements that advertising targets should not own the Apple Watch, but be connected to someone who does. Querying the profiling database 150, it may be determined that user 902 calls 910 user 912 frequently. Accordingly, user 912 may be an advertising target and an advertisement for the Apple Watch appears on their device 914. Similarly, it may be determined that user 902 texts user 922 frequently. Accordingly, user 922 may be an advertising target and an advertisement for the Apple Watch appears on their device 924. It may also be determined that user 902 is in close proximity 930 with user 932. Accordingly, user 932 may be an advertising target and an out of home digital advertisement 934 for the Apple Watch may appear.

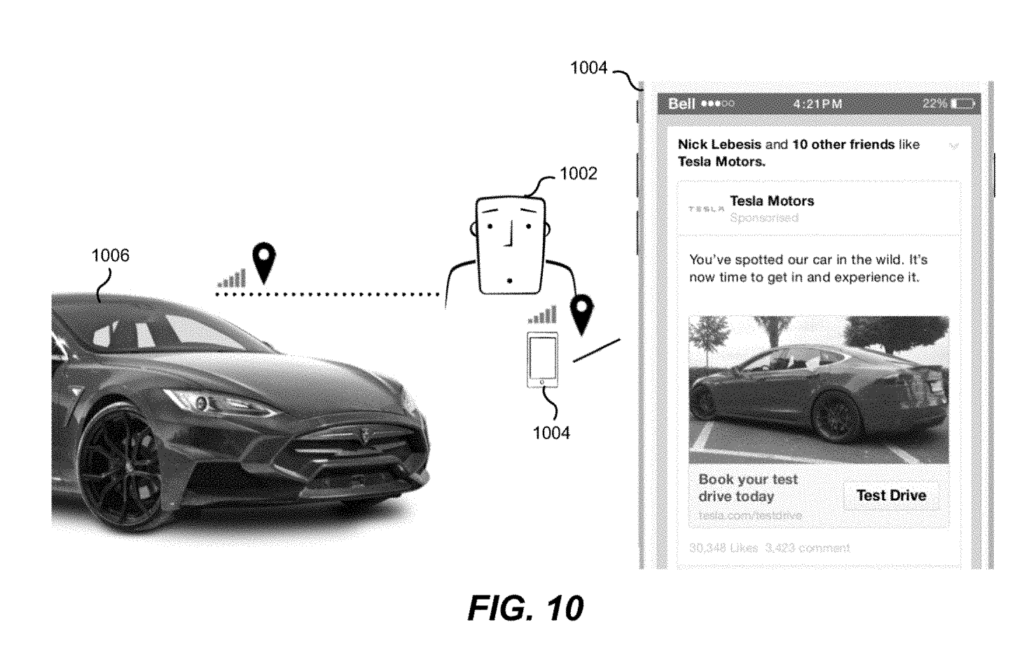

FIG. 10 depicts an example of targeted advertising based on proximity determination. Advertising with IoT retargeting allows for advertisers to retarget audiences based on real-world experiences. Exposure effect theory indicates that exposure to a stimulus increases chances of liking it. Users/actors are exposed to connected IoT objects as they move throughout the world, such as connected cars, wearable devices, etc. Advertisers may retarget products and objects to people who have observed them in the real world. This information may be gathered by collecting location, time, object, and frequency data related to individuals and objects.

In this example, consider user 1002 of mobile device 1004. The mobile device 1004 is connected to a mobile network and has location services. The IoT device 1006 is a Tesla, which is also connected to the mobile network and has location services. The positioning of the user 1002 (through device 1004) and car 1006 may be tracked as they move throughout the world. As described with respect to FIG. 1, this GPS information of the device 1004 and the Tesla 1006 may be received and used to generate edges between the device 1004 and Tesla 1006 when they are in close proximity. A relationship between the device 1004 and the Tesla 1006 may be inferred based on repeated location proximity, and a social graph profile may be stored in the profiling database 150. For example, a social graph profile for the user 1002 of device 1004 may reveal that the user is repeatedly in close proximity to Teslas.

An advertiser may want to run Tesla advertisements based on how often people have seen the cars in life. Target profile parameters may be that a user has seen a Tesla three times within the past month. This may be determined by evaluating the proximity of a user in relation to Tesla cars, where a user of a device has been deemed to ‘see’ a Tesla if the device has been at a distance of 100-200 m from a Tesla, and if on average the device and a Tesla are in this proximity for three minutes. The one or more network servers 130 may receive the advertising request, query the profiling database 150 with these target profile parameters, and provide social graph profile information associated with nodes that match these parameters. The Tesla advertisement may be displayed on the relevant devices as determined from the profile associated with a node representing that device. In this example, a Tesla advertisement is displayed on device 1004.

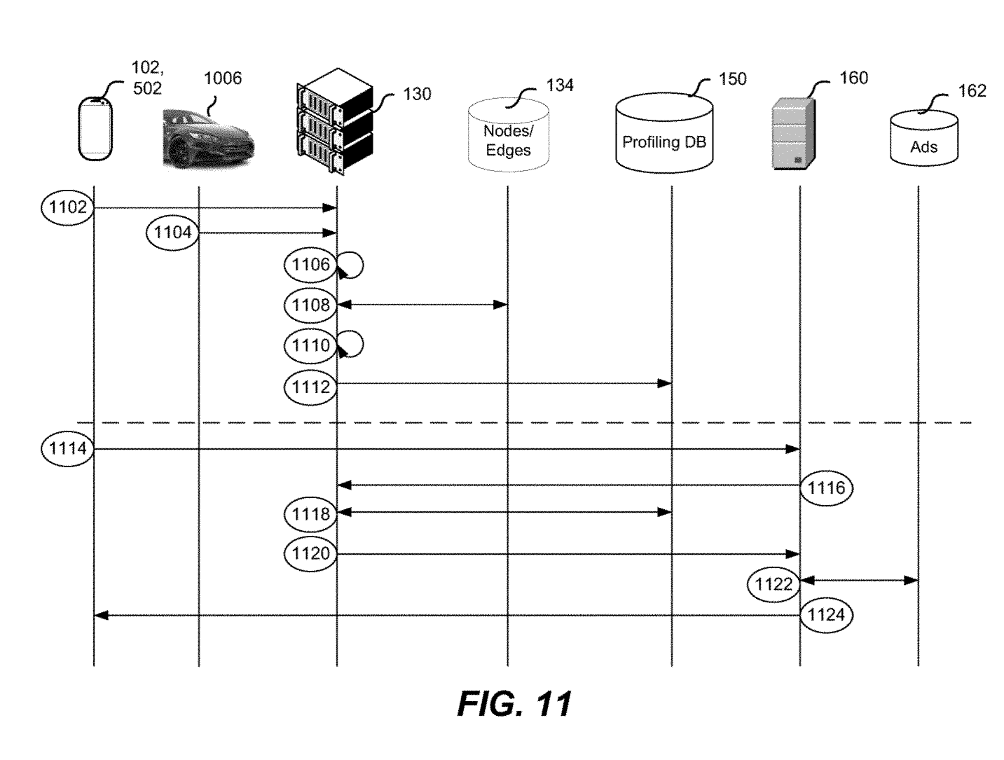

FIG. 11 depicts a communication flow diagram for targeted advertising based on proximity determination. The communication flow diagram shown in FIG. 11 may be substantially the same as the communication flow diagram shown in FIG. 7, except that the one or more network servers 130 also receive mobile data, and particularly location data, from an IoT device, which is exemplary depicted as the Tesla 1006 from FIG. 10.

Mobile data is received at the one or more network servers 130 from a node, such as device 102 or 502 (1102). Mobile data is also received at the one or more network servers 130 from the connected Tesla 1006 (1104). The Tesla 1006 may comprise a sensor that can provide information about the car and the region surrounding the car, such as the model of car, the location of the car, the time that the car is in the location, etc.

The one or more network servers 130 may determine node and edge information based on the received mobile data from the device 102 or 502 and the Tesla 1006 (1106). Specifically, the one or more network servers may respectively identify the device and the Tesla, and determine location proximity between the device 102 or 502 and the Tesla 1006.

The node and edge information may be stored in the nodes/edges database 134, and the one or more network servers 130 may also retrieve/access data from the nodes/edges database 134 to be used for inferring relationships (1108). The one or more network servers 130 may infer relationships from the social graph information contained in the nodes and edges database 134, and generate a social graph profile for one or more of the nodes (1110). The one or more network servers 130 may apply relationship threshold parameters to infer the relationships. The relationship threshold parameters used to infer a proximity relationship between the device 102 or 502 and the Tesla 1006 may be a threshold frequency of interactions, accumulated time of interactions, etc., where each interaction is an instant when the device 102 or 502 and the Tesla 1006 are within a predetermined proximity to one another. However, the relationship may not necessarily have to be only between the device 102 or 502 and the specific Tesla 1006. The one or more network servers 130 may aggregate all interactions that the user of device 102 or 502 has had with any Tesla to develop the social graph profile for the user of device 102 or 502. The social graph profile may be stored in the profiling database 150 (1112). In this example, a social graph profile for the user of device 102 or 502 is stored in the profiling database 150.

The device 102 or 502 may subsequently make an advertisement request from advertisement server 160 (1114). This may occur, for example, when the user of the device 102 or 502 visits a webpage with an advertisement located therein. The advertisement server 160 may query the one or more network servers 130 to retrieve a social graph profile, or a part thereof, for the user of device 102 or 502 (1116). The one or more network servers 130 may access the profiling database 150 to retrieve the social graph profile for the user of device 102 or 502 (1118), and send the social graph profile to the advertisement server 160 (1120). The advertisement server 160 may access the advertisement database 162 to retrieve an appropriate/targeted advertisement specific to the user of the device 102 or 502 based on the received social graph profile (1122). The advertisement server 160 may send the targeted advertisement to the device 102 or 502 (1124).

As with the communication flow diagram of FIG. 7, the steps in the communication flow diagram depicted in FIG. 11 do not necessarily have to be performed in that order. For example, as has been previously described the advertisement server 150 may make requests to the one or more network servers 130 in advance of receiving a request from a device. The request may comprise target profile parameters, thereby allowing the advertisement server 160 to identify specific devices to which it wishes to target with advertisements. The target profile parameters may also represent the relationship threshold parameters for determining relationships between nodes. When an ad request is then received at the advertisement server 160, the advertisement server 160 may immediately present the previously allocated advertisement to the device.

It would be appreciated by one of ordinary skill in the art that the system and components shown in FIGS. 1-11 may include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

1. A method of generating social graph information, comprising:
receiving mobile data from a device corresponding to a first node within a set of a plurality of nodes;
generating an edge between the first node and a second node within the set of the plurality of nodes based on the mobile data received, the edge representing how the first node and the second node are connected;
inferring a relationship between the first node and the second node based on the edge;
generating a social graph profile for at least one of the first node and the second node based on the inferred relationship; and
storing the social graph profile in a profiling database.

2. The method of claim 1, wherein the relationship is inferred based on the edge and one or more existing edges generated from previously received mobile data.

3. The method of claim 2, wherein the relationship is inferred by applying one or more relationship threshold parameters to the edge and the one or more existing edges.

4. The method of claim 1, wherein the edge is any one or more of: a call between the first and second nodes, a text message between the first and second nodes, and location proximity of the first and second nodes.

5. The method of claim 1, wherein the social graph profile further comprises customer relationship management information.

6. The method of claim 1, wherein the mobile data comprises any one or more of text messages, phone calls, e-mails, browsing activity, and location information.

7. The method of claim 1, further comprising:
receiving an advertising request from an advertising server, the advertising request include target profile parameters;
determining one or more target nodes by querying the profiling database for one or more nodes that match the target profile parameters;
retrieving a social graph profile associated with each of the one or more target nodes; and
transmitting the social graph profile to the advertising server.

8. The method of claim 7, wherein the one or more target nodes have subscribed to a targeted advertising program.

9. The method of claim 8, wherein the first node is determined to be a targeted node based on the first node's relationship with the second node.

10. A system for generating social graph information, comprising:
a network server operably coupled with a mobile network; and
a memory operably coupled with the network server, the memory containing instructions which when executed by the network server configure the network server to:
receive mobile data from a device corresponding to a first node within a set of a plurality of nodes;
generate an edge between the first node and a second node within the set of the plurality of nodes based on the mobile data received, the edge representing how the first node and the second node are connected;
infer a relationship between the first node and the second node based on the edge;
generate a social graph profile for at least one of the first node and the second node based on the inferred relationship; and
store the social graph profile in a profiling database.

11. The system of claim 10, wherein the relationship is inferred based on the edge and one or more existing edges generated from previously received mobile data.

12. The system of claim 11, wherein the relationship is inferred by applying one or more relationship threshold parameters to the edge and the one or more existing edges.

13. The system of claim 10, wherein the edge is any one or more of: a call between the first and second nodes, a text message between the first and second nodes, and location proximity of the first and second nodes.

14. The system of claim 10, wherein the social graph profile further comprises customer relationship management information.

15. The system of claim 10, wherein the mobile data comprises any one or more of text messages, phone calls, e-mails, browsing activity, or location.

16. The system of claim 10, the memory containing further instructions which when executed by the network server configure the network server to:
receive an advertising request from an advertising server, the advertising request include target profile parameters;
determine one or more target nodes by querying the profiling database for one or more nodes that match the target profile parameters;
retrieve a social graph profile associated with each of the one or more target nodes; and
transmit the social graph profile to the advertising server.

17. The system of claim 16, wherein the one or more target nodes have subscribed to a targeted advertising program.

18. The system of claim 17, wherein the first node is determined to be a targeted node based on the first node's relationship with the second node.
